(19) United States
(12) Patent Application Publication
(10) Pub. No.: US 2023/0385880 A1
(43) Pub. Date: Nov. 30, 2023

(54) SALES PROMOTION SUPPORT DEVICE, SALES PROMOTION SUPPORT METHOD, AND RECORDING MEDIUM

(71) Applicant: NEC Corporation, Tokyo (JP)

(72) Inventor: Aiko YAMATANI, Tokyo (JP)

(73) Assignee: NEC Corporation, Tokyo (JP)

(21) Appl. No.: 18/122,436

(22) Filed: Mar. 16, 2023

(30) Foreign Application Priority Data
May 31, 2022 (JP) 2022-089043

(51) Int. Cl. G06Q 30/0251

(52) U.S. Cl. CPC G06Q 30/0269

(57) ABSTRACT

A sales promotion support device according to the present disclosure includes: one or more memories storing instructions; and one or more processors configured to execute the instructions to: acquire at least one of behavior information that is information regarding a behavior of a user and a time at which a sales promotion plan is to be provided; estimate an acceptability of the user to a sales promotion plan based on the at least one of the behavior information and the time; and determine a sales promotion plan to be provided to the user according to the acceptability.

This application is based upon and claims the benefit of priority from Japanese Patent Application No. 2022-089043, filed on May 31, 2022, the disclosure of which is incorporated herein in its entirety by reference.

### TECHNICAL FIELD

The present disclosure relates to a technology or the like for supporting provision of sales promotion to a user.

### BACKGROUND ART

JP 2008-217222 A discloses a sales promotion system that sets a sales promotion plan according to a sales situation.

In the sales promotion system described in JP 2008-217222 A, a user's situation is not considered at the time of setting the sales promotion plan, and the user may feel annoyed about the sales promotion plan.

### SUMMARY

An example object of the present disclosure is to support provision of a sales promotion plan that does not make a user feel annoyed.

A sales promotion support device according to an aspect of the present disclosure includes: one or more memories storing instructions; and one or more processors configured to execute the instructions to: acquire at least one of behavior information that is information regarding a behavior of a user and a time at which a sales promotion plan is to be provided; estimate an acceptability of the user to a sales promotion plan based on the at least one of the behavior information and the time; and determine a sales promotion plan to be provided to the user according to the acceptability.

A sales promotion support method performed by a computer according to an aspect of the present disclosure includes: acquiring at least one of behavior information that is information regarding a behavior of a user and a time at which a sales promotion plan is to be provided; estimating an acceptability of the user to a sales promotion plan based on the at least one of the behavior information and the time; and determining a sales promotion plan to be provided to the user according to the acceptability.

A recording medium according to an aspect of the present disclosure records a sales promotion support program causing a computer to execute: acquiring at least one of behavior information that is information regarding a behavior of a user and a time at which a sales promotion plan is to be provided; estimating an acceptability of the user to a sales promotion plan based on the at least one of the behavior information and the time; and determining a sales promotion plan to be provided to the user according to the acceptability.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a sales promotion support device according to an example embodiment;

FIG. 2 is a diagram illustrating a concept of a sales promotion support system according to the present disclosure;

FIG. 3 is a block diagram illustrating a configuration of a sales promotion support device in a case where an acceptability is estimated using a moving speed according to the example embodiment;

FIG. 4 is a diagram illustrating an example of information indicating a relationship between a moving speed and an acceptability according to the example embodiment;

FIG. 5 is a diagram illustrating an example of information indicating a relationship between a time and an acceptability according to the example embodiment;

FIG. 6 is a diagram illustrating an example of information indicating a relationship between a behavior schedule and an acceptability according to the example embodiment;

FIG. 7 is a diagram illustrating an example of information in which an acceptability and a sales promotion plan are associated with each other according to the example embodiment;

FIG. 8 is a diagram illustrating an example of information in which an acceptability and a sales promotion plan are associated with each other according to the example embodiment;

FIG. 9 is a flowchart illustrating an example of an operation of the sales promotion support device according to the example embodiment;

FIG. 10 is a block diagram illustrating a configuration of a sales promotion support device according to a first modification; and

FIG. 11 is a diagram illustrating a hardware configuration in which the sales promotion support device according to the present disclosure is implemented by a computer device and its peripheral device.

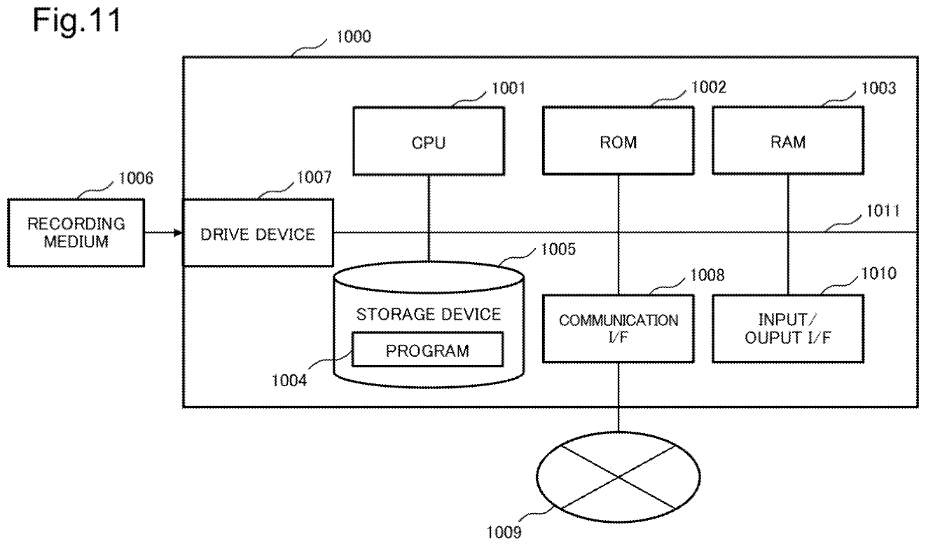

### EXAMPLE EMBODIMENT

Next, Example embodiments of the present disclosure will be described in detail with reference to the drawings.

### Example Embodiment

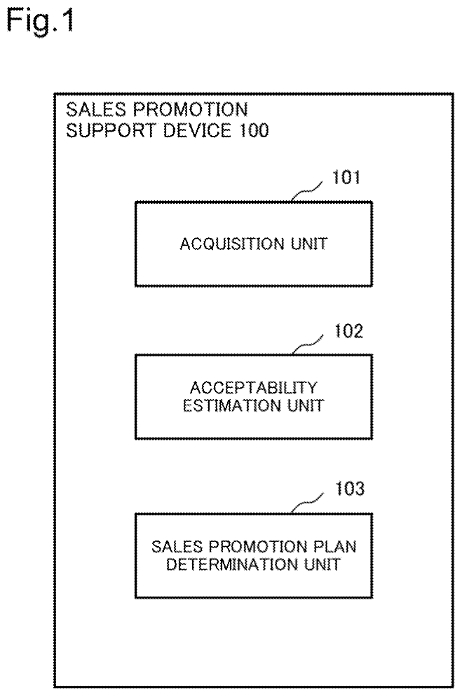

FIG. 1 is a block diagram illustrating a configuration of a sales promotion support device 100 according to an example embodiment. Referring to FIG. 1, the sales promotion support device 100 includes an acquisition unit 101, an acceptability estimation unit 102, and a sales promotion plan determination unit 103. The acquisition unit 101 acquires information used for estimating acceptability. The acceptability estimation unit 102 estimates an acceptability of the user to a sales promotion plan. Then, the sales promotion plan determination unit 103 determines a sales promotion plan to be provided to the user according to the acceptability.

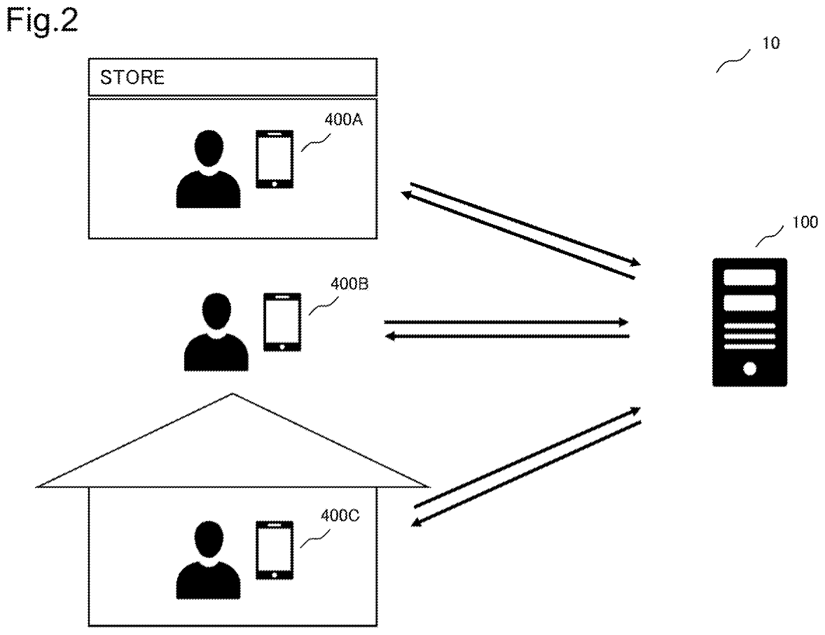

An example in which the sales promotion support device 100 according to the present disclosure is used will be described. The sales promotion support device 100 is included in a sales promotion support system provided to a user terminal. FIG. 2 is a diagram illustrating a concept of the sales promotion support system 10.

In FIG. 2, the sales promotion support system 10 is a system that provides a sales promotion plan to the user, that is, the user terminal. The sales promotion plan is a plan provided to the user terminal for sales promotion. The sales promotion plan is, for example, a video for introducing a product or a store. As another example, the sales promotion plan is a plan such as a stamp rally for promoting migration of the user. Note that the sales promotion plan is not limited to these examples. In addition, the place where the user executes the sales promotion plan may be inside or outside a store.

In the sales promotion support system 10, a sales promotion plan determined by the sales promotion support device 100 is provided to the user terminal by the sales promotion support device 100, an external server, or a cloud computing system.

For example, the sales promotion plan is provided to the user by providing, to the user terminal, image data such as a moving image for introducing a product for which sale is promoted. As another example, the sales promotion plan is provided to the user by providing, to the user terminal, data for causing the user terminal to execute a plan for promoting migration of the user in the store. As another example, the sales promotion plan is provided to the user by providing, to the user terminal, data for causing the user terminal to execute a questionnaire to check the user's needs. The provided data is, for example, data for the user to execute the sales promotion plan in a browser or an application of the user terminal.

Referring back to FIG. 2, the description will be made. The sales promotion support system 10 includes a sales promotion support device 100, a user terminal 400A, a user terminal 400B, and a user terminal 400C. The user terminal 400A, the user terminal 400B, and the user terminal 400C are also referred to as user terminal 400.

In the sales promotion support system 10, the sales promotion support device 100, and the user terminal 400 are communicably connected to each other. In addition, the sales promotion support device 100 and the user terminal may be communicably connected to an external database.

As will be described below, the sales promotion support device 100 estimates an acceptability of the user, and determines a sales promotion plan according to the acceptability. The sales promotion support device 100 may be implemented as a server or a cloud computing system.

The user terminal 400 is a terminal device used by the user. The user terminal 400 may be a terminal owned by the user or a terminal installed in a shopping cart of the store. The user terminal 400 to which the sales promotion plan is provided may be a user terminal 400A inside the store, a user terminal 400B outside the store, or a user terminal 400C at the user's home. That is, the user for which an acceptability is to be estimated and a sales promotion plan is to be determined by the sales promotion support system 10 is not limited to the user in the store. Furthermore, the number of user terminals 400 is not limited to the example of FIG. 2.

Next, referring back to FIG. 1, the configuration of the sales promotion support device 100 according to the example embodiment will be described in detail. In FIG. 1, the acquisition unit 101 is an example of an acquisition means configured to acquire at least one of behavior information that is information regarding a behavior of the user and a time at which a sales promotion plan is to be provided. The behavior information that is information regarding the behavior of the user and the time at which the sales promotion plan is provided are information used by the acceptability estimation unit 102 to estimate an acceptability of the user to the sales promotion plan. The behavior information is information used for estimating a behavior of the user when the sales promotion plan is provided. For example, the behavior information includes information such as a behavior history of the user, position information indicating a current behavior of the user, moving speed information, an image of the user captured by a monitoring camera in a store or outdoors, a behavior schedule of the user, and attribute information related to a behavior of the user. The time at which the sales promotion plan is provided may be a current time. Alternatively, the time at which the sales promotion plan is provided may be a future time determined in advance to provide the sales promotion plan. The acquisition unit 101 may acquire such information from the user terminal or the external database. In addition, the acquisition unit 101 may include a detection unit, although not illustrated, to detect information used for estimating an acceptability by itself.

The acceptability estimation unit 102 is an example of an acceptability estimation means configured to estimate an acceptability of the user to a sales promotion plan based on at least one of behavior information that is information regarding a behavior of the user and a time at which the sales promotion plan is provided. The acceptability is a degree of whether the user accepts the sales promotion plan. In other words, the acceptability is a probability that the user executes the sales promotion plan, a probability that the user participates in the sales promotion plan, or a degree of whether the user is in such a situation as to easily participate in the sales promotion plan. For example, the acceptability estimation unit 102 estimates an acceptability based on at least one of information indicating a relationship between the behavior information and the acceptability and information indicating a relationship between the time and the acceptability.

The acceptability may be expressed in several levels. For example, the acceptability may be expressed in multiple levels such as “high”, “medium”, and “low”. Alternatively, the acceptability may be expressed in numerical values such as “1” to “100”. Also, there may be no acceptability, such as “none” or “0 (zero)”. How to express the acceptability is not limited to these examples.

An example of how the acceptability estimation unit 102 estimates an acceptability will be described. For example, the acceptability estimation unit 102 estimates an acceptability of the user to the sales promotion plan by estimating whether the user is in a hurry based on the behavior information or the time. When the user is in a hurry, it is assumed that the user has no time to execute the sales promotion plan. On the other hand, when the user is not in a hurry, it is assumed that the user has time to execute the sales promotion plan. In the following description, whether the user is in a hurry will also be referred to as temporal acceptability.

First, an example in which the acceptability estimation unit 102 estimates a temporal acceptability based on behavior information will be described. For example, the acceptability estimation unit 102 estimates an acceptability by estimating whether the user is in a hurry based on a moving speed of the user. The moving speed of the user is an example of behavior information that is information regarding a behavior of the user. The moving speed may be, for example, an average moving speed from a current time to a predetermined time ago, a moving speed after entering the store, or a current moving speed.

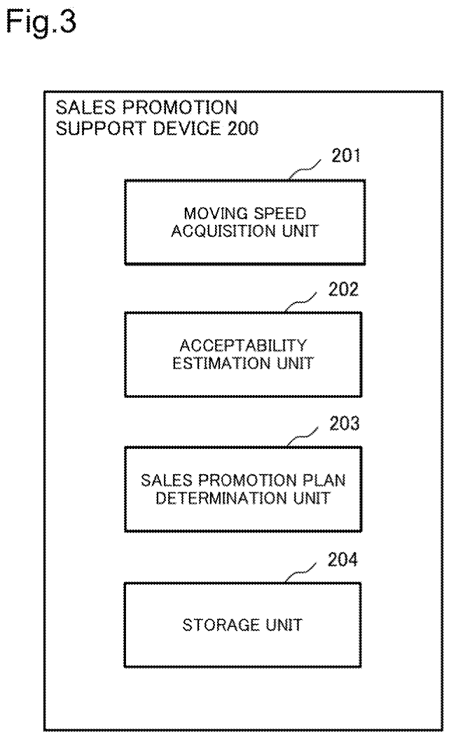

As an example of a sales promotion support device in a case where an acceptability is estimated based on a moving speed of the user, a sales promotion support device 200 will be described with reference to FIG. 3.

In FIG. 3, the sales promotion support device 200 includes a moving speed acquisition unit 201, an acceptability estimation unit 202, a sales promotion plan determination unit 203, and a storage unit 204. The moving speed acquisition unit 201 is an example of an acquisition unit. Similarly to the sales promotion support device 100, the sales promotion support device 200 may be applied to the sales promotion support system.

The moving speed acquisition unit 201 first acquires a moving speed of the user. The moving speed of the user may be a moving speed of the user terminal. The moving speed of the user terminal is detected, for example, by the user terminal or an external device communicably connected to the user terminal. For example, the moving speed of the user terminal may be calculated using a change in position information of the user terminal and a change in time.

Next, the acceptability estimation unit 202 estimates an acceptability based on the acquired moving speed of the user. For example, the acceptability estimation unit 202 estimates an acceptability, using the acquired moving speed of the user, with reference to information indicating a relationship between a moving speed and an acceptability stored in the storage unit 204.

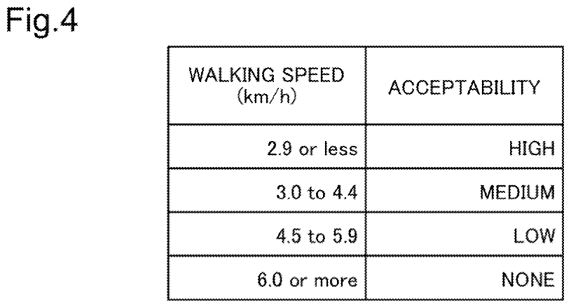

FIG. 4 is an example of information indicating a relationship between a moving speed and an acceptability stored in the storage unit 204. When the moving speed of the user is large, it is assumed that the user is moving in a hurry, that is, the user has no time to execute the sales promotion plan. On the other hand, when the moving speed of the user is low, it is assumed that the user is moving slowly, that is, the user has time to execute the sales promotion plan. Therefore, as illustrated in FIG. 4, the acceptability may be set, for example, to be lower as the moving speed is higher and to be higher as the moving speed is lower. In addition, in the example of FIG. 4, the acceptability is indicated in the level of “high”, “medium”, or “low”. For example, in the example of FIG. 4, in a case where the moving speed of the user is 2.5 km/h, the acceptability estimation unit 202 estimates an acceptability as “high”, that is, the acceptability is high.

In addition, as illustrated in the example of FIG. 4, when the moving speed is larger than a certain value, the acceptability may be set to “none”. The case where the acceptability is “none” will be described in a second modification.

Note that the information indicating a relationship between a moving speed and an acceptability is not limited to these examples. The information indicating a relationship between a moving speed and an acceptability may be set for each user. In this case, the relationship between the moving speed and the acceptability may be set using, for example, an average value, a median value, a maximum value, a minimum value, or the like of past moving speeds of the user. For example, when the speed is in the range of −0.5 to +0.5 from the average value, the acceptability may be set as “medium”, or when the speed is in the range of −1.0 or more from the maximum value, the acceptability may be set as “high”.

Alternatively, the information indicating a relationship between a moving speed and an acceptability may be set for each user attribute. A user attribute considered to have a change in the relationship between the moving speed and the acceptability is age, whether there is a walking aid, whether there is a child, or the like, in which there is a difference in moving speed, that is, walking speed.

Furthermore, in a case where the information indicating the relationship between the moving speed and the acceptability is set for each user or for each user attribute, the acceptability estimation unit 202 acquires identification information of the user or the user attribute. Then, the acceptability estimation unit 202 may estimate an acceptability with reference to the information indicating the relationship between the moving speed and the acceptability associated with the identification information of the user or the user attribute. The identification information of the user is information capable of identifying the user. The identification information is, for example, a character string. Further, the identification information of the user may be identification information of a user terminal.

Note that the method for estimating an acceptability by estimating whether the user is in a hurry using a moving speed is not limited to the example of the sales promotion support device 200. For example, the storage unit 204 may be a storage device communicably connected to the outside.

Next, an example in which the acceptability estimation unit 102 estimates a temporal acceptability based on time will be described. For example, the acceptability estimation unit 102 estimates an acceptability by estimating whether the user is in a hurry based on a current time. It is considered that the acceptability of the user may change depending on the time. In this case, the acceptability estimation unit 102 first acquires a current time. Next, the acceptability estimation unit 102 estimates an acceptability based on the time. For example, the acceptability estimation unit 102 estimates an acceptability, using the acquired time, with reference to information indicating a relationship between the time and the acceptability. The information indicating the relationship between the time and the acceptability is stored in a storage unit communicably connected to the sales promotion support device 100 inside or outside the sales promotion support device 100.

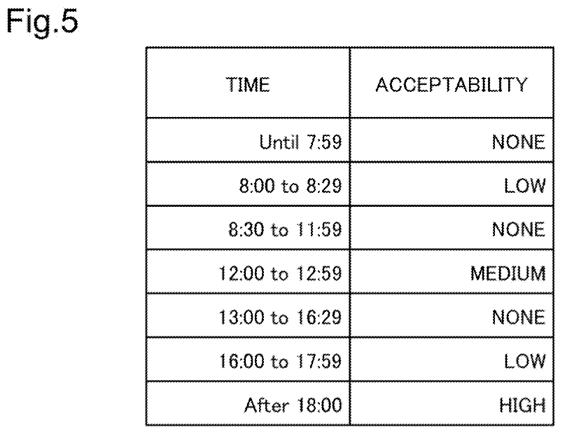

FIG. 5 is an example of information indicating a relationship between a time and an acceptability. FIG. 5 is an example of information indicating a relationship between a time and an acceptability in a case where an acceptability changes in a day because the user works.

As illustrated in FIG. 5, for example, in a case where it is assumed that the user works in the daytime, the acceptability is set in consideration of a commuting time and a working time. For example, in the example of FIG. 5, the acceptability is set to “none” in a time zone until leaving home and in a time zone expected to be a working time. In a morning commuting time zone and in an evening commuting time zone, the acceptability is set to “low”. It is assumed that, in a time zone until leaving home and a morning commuting time zone, the acceptabilities are set to “none” and “low”, respectively, because the user is likely to be in a hurry. In addition, in a case where the user has a child, it is assumed that, in an evening commuting time zone, the acceptability is set to “low” because there is a high possibility that the user is in a hurry to pick up the child or the like. Furthermore, as illustrated in FIG. 5, the acceptability is set to “medium” in a time zone expected to be a break time. In a time zone expected to be after returning home, the acceptability is set to “high”. The reason why the acceptabilities are set to “medium” and “high” in the break time zone and the time zone after returning home is that it is assumed that the user is not in a hurry during the break time and after returning home. For example, in a case where the current time is 8:15, the acceptability estimation unit 102 estimates the acceptability as “low”.

Note that the relationship between a time and an acceptability is not limited to these examples. For example, the relationship between the time and the acceptability may be set only for a predetermined period of time of a day. For example, the acceptability in a morning time zone may be set to be low, and the acceptabilities in other time zones may be set after being estimated by other methods.

As another example, the information indicating a relationship between a time and an acceptability may be set for each user. In this case, the relationship between the time and the acceptability may be set, for example, using an operation log of the user terminal. In a time zone when the user terminal tends not to be operated, the acceptability may be set to be low because it is considered that there is a low possibility that the user operates the user terminal to execute the sales promotion plan. Alternatively, the relationship between the time and the acceptability may be set by a user's input.

Alternatively, the information indicating a relationship between a time and an acceptability may be set for each user attribute. The user attribute considered to have a variable relationship between a time and an acceptability is an occupation, where there is a child, or the like. Furthermore, the information indicating the relationship between the time and the acceptability may be set to be different between weekday and weekend, and holiday, or between working day and non-working day.

Furthermore, in a case where the information indicating the relationship between the time and the acceptability is set for each user or for each user attribute, the acceptability estimation unit 102 acquires identification information of the user or the user attribute. Then, the acceptability estimation unit 102 may estimate an acceptability with reference to the information indicating the relationship between the time and the acceptability associated with the identification information of the user or the user attribute.

Next, an example in which the acceptability estimation unit 102 estimates a temporal acceptability based on behavior information and time will be described. For example, the acceptability estimation unit 102 estimates an acceptability by estimating whether the user is in a hurry based on a behavior schedule of the user. The behavior schedule of the user is an example of behavior information that is information regarding a behavior of the user. The behavior schedule includes at least information on a time at which there is a schedule. Furthermore, the behavior schedule may include information on a content, an importance, a place or the like of the schedule. The behavior schedule may be, for example, one input by the user through a questionnaire. In this case, the behavior schedule may be stored in the storage unit of the sales promotion support device 100 in association with the identification information of the user. Alternatively, the behavior schedule may be input by the user through a calendar application or the like in the terminal device used by the user and stored in a storage unit communicably connected to the inside or the outside of the user terminal.

In this case, the acceptability estimation unit 102 first acquires identification information of the user. Then, the acceptability estimation unit 102 acquires a behavior schedule of the user associated with the identification information of the user. Next, the acceptability estimation unit 102 estimates an acceptability based on the behavior schedule of the user. For example, the acceptability estimation unit 102 estimates an acceptability using the behavior schedule of the user and information indicating a relationship between the behavior schedule and the acceptability. The information indicating the relationship between the behavior schedule and the acceptability is stored in a storage unit communicably connected to the inside or the outside.

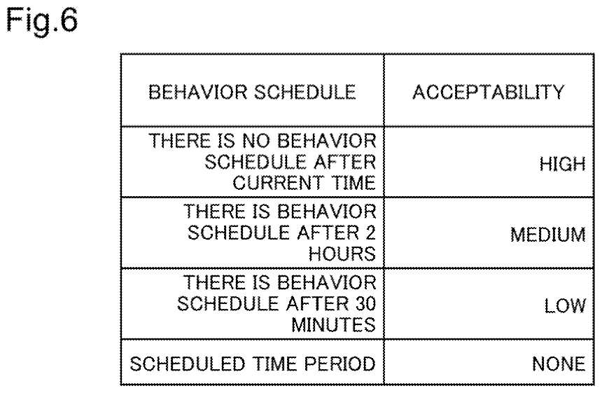

FIG. 6 is an example of information indicating a relationship of whether there is a behavior schedule and a time until the behavior schedule with an acceptability. When it is close to the scheduled period of time, it is assumed that the user may be in a hurry for preparation or movement. Therefore, for example, as illustrated in FIG. 6, the acceptability may be set at a certain time to be high if there is no schedule from that time, low as the time approaches a scheduled period of time, and none while the time is the scheduled period of time. For example, when there is a behavior schedule of the user, the acquisition unit 101 acquires a current time. Then, the acceptability estimation unit 102 calculates a time until the scheduled period of time, which is a time zone in which there is a schedule, starts. Then, the acceptability estimation unit 102 estimates an acceptability according to the calculated time and information indicating the relationship between whether there is a behavior schedule and the acceptability illustrated in FIG. 6. Note that the information indicating a relationship of whether there is a behavior schedule and a time until the behavior schedule with an acceptability is not limited thereto.

Furthermore, in a case where the behavior schedule is used for estimating an acceptability, the acceptability estimation unit 102 may estimate an acceptability further using position information of the user. In a case where the behavior schedule includes a behavior schedule place, the acquisition unit 101 acquires a time required for movement from the current position to the behavior schedule place. Then, the acceptability estimation unit 102 compares a difference between a start time of the behavior schedule and the current time with the acquired time required for movement from the current position to the planned behavior place. For example, the acceptability estimation unit 102 may estimate the acceptability to be higher as the time until the start time of the behavior schedule is longer than the time required for movement.

Next, another example of how the acceptability estimation unit 102 estimates an acceptability will be described. For example, the acceptability estimation unit 102 estimates an acceptability of the user to the sales promotion plan by estimating whether it is easy to move around based on at least one of the behavior information and the time. In this case, the sales promotion plan is a plan for promoting a visit to the store or promoting migration in the store.

The plan for promoting migration in the store is, for example, executing a predetermined operation at a predetermined point. Specifically, the plan for promoting migration in the store may be a plan such as a stamp rally performed by executing a predetermined operation of reading, with the user terminal, a barcode of a product in the store as a predetermined point, a two-dimensional code provided on a product shelf in the store as a predetermined point or the like. Furthermore, the plan for promoting migration in the store is not limited to this example.

The acceptability estimation unit 102 estimates whether it is easy to move around based on behavior information that is information regarding a behavior of the user. In the following description, whether it is easy for the user to move around will also be referred to as a walk-around acceptability.

For example, the acceptability estimation unit 102 estimates how easy it is for the user to move around based on a behavior history of the user as behavior information. It is considered that how easy it is for the user to move around varies depending on an amount of baggage or a person or animal accompanied with the user. For example, the acceptability estimation unit 102 estimates an acceptability by estimating an amount of baggage or a person or an animal accompanied with the user based on a behavior history of the user for a predetermined period.

The behavior history of the user is, for example, information indicating a facility visited by the user, which is estimated from the history of the position information of the user terminal. Alternatively, the behavior history of the user may be information indicating a means of transportation used by the user, which is estimated from the history of the position information of the user terminal. The user terminal or the acceptability estimation unit 102 estimates a behavior history based on the history of the position information. The behavior history of the user may be stored in a storage unit communicably connected to the inside or the outside of the sales promotion support device 100 in association with the identification information of the user. Furthermore, the behavior history of the user stored in the storage unit may be a behavior history for a most recent predetermined period.

For example, the acceptability estimation unit 102 estimates whether the user is accompanied by a child based on the behavior history of the user. First, the acceptability estimation unit 102 acquires position information of the user terminal. The acceptability estimation unit 102 determines whether the user drops by a facility for children such as a nursery school, a kindergarten, or a cram school after leaving the office in the afternoon and before coming to the store, from the history of the position information of the user terminal. For example, in a case where the position information does not change for a predetermined period of time or more in a predetermined facility, the acceptability estimation unit 102 determines that the user has dropped by the facility. When it is determined that the user has dropped by a facility for children, such as a nursery school, a kindergarten, or a cram school, the acceptability estimation unit 102 estimates that the user visits the store together with a child. In a case where the user is accompanied by a child, the acceptability estimation unit 102 may estimate that the acceptability is low because it is considered difficult for the user to look around for products.

As another example, the acceptability estimation unit 102 estimates whether the user has baggage based on the behavior history of the user. When it is determined that the user has dropped by at a plurality of different stores based on the behavior history of the user, it is assumed that the user has baggage bought at the other stores. In a case where there are a lot of baggage, the acceptability estimation unit 102 may estimate that the acceptability is low because it is considered difficult for the user to walk around. Furthermore, the acceptability estimation unit 102 may estimate an amount of baggage using information on a purchase at another store such as payment information of the user in addition to the behavior history.

The acceptability estimation unit 102 may estimate an acceptability by combining two or more of the acceptability estimating methods described so far. For example, the acceptability estimation unit 102 may set a total value of a temporal acceptability and a walk-around acceptability as an acceptability of the user.

Furthermore, the acceptability estimation unit 102 may estimate a probability that the sales promotion plan is executed, that is, an acceptability, by inputting behavior information and a time to a trained model that has learned data indicating a relationship of the behavior information and the time with whether the user executes the sales promotion plan as teacher data. More specifically, the data indicating the relationship of the behavior information and the time with whether the user executes the sales promotion plan is data in which whether the user has executed the sales promotion plan is labeled as a correct answer label with respect to the behavior information of the user and the time.

The sales promotion plan determination unit 103 is an example of a sales promotion plan determination means configured to determine a sales promotion plan to be provided to the user according to the acceptability. The sales promotion plan determination unit 103 determines at least one of a type and an amount of a sales promotion plan according to the acceptability estimated by the acceptability estimation unit 102. For example, the sales promotion plan determination unit 103 determines a sales promotion plan, using the acceptability, with reference to predetermined information in which at least one of a type and an amount of a sales promotion plan is associated with the acceptability. The information in which at least one of a type and an amount of a sales promotion plan is associated with the acceptability is stored in a storage unit communicably connected to the inside or the outside of the sales promotion support device 100.

The type of sales promotion plan is a type of plan itself, such as watching an advertisement video, performing a stamp rally in which products in a store are scanned around, and answering a questionnaire. There may be one or more types of sales promotion plans.

Furthermore, for each type of sales promotion plan, there may further be a type of a content such as a product or a manufacturer. The type of the content of the sales promotion plan may be determined according to a preference of the user. The preference of the user is estimated, for example, based on a user attribute, purchase history information of the user, information indicating an interest of the user, and the like stored in association with the identification information of the user. As the information indicating the interest of the user, a product or a category of interest may be estimated from a stay time while walking in the store or browsing a web browser, or information may be input by the user through a questionnaire or the like.

The amount of sales promotion plan is the number of times the user executes the sales promotion plan or a time for which the user executes the sales promotion plan. As the amount of sales promotion plan is larger, the user has a greater burden in executing the sales promotion plan. The amount of sales promotion plan may be a time in a case where the sales promotion plan is watching a moving image, the number of scans in a case where the sales promotion plan is a stamp rally, or the number of questions in a case where the sales promotion plan is a questionnaire. Alternatively, the amount of sales promotion plan may be an estimated time required for the stamp rally or the questionnaire.

The sales promotion plan determination unit 103 determines, as a sales promotion plan to be provided to the user, a sales promotion plan imposing a higher burden on the user in executing the sales promotion plan as the acceptability is higher. Also, the sales promotion plan determination unit 103 determines, as a sales promotion plan to be provided to the user, a sales promotion plan imposing a lower burden on the user in executing the sales promotion plan as the acceptability is lower.

The burden on the user in executing the sales promotion plan is, for example, a large amount of the sales promotion plan described above. In order for the user to execute a sales promotion plan imposing a high burden, a high acceptability is required. Furthermore, the burden on the user in executing the sales promotion plan also varies depending on a type of a sales promotion plan. For example, a sales promotion plan requiring the user to move around in the store imposes a high burden from the viewpoint of moving around. That is, a sales promotion plan requiring the user to move around in the store imposes a higher load than a sales promotion plan that can be executed even though the user is stopped such as watching a moving image or answering a questionnaire.

For example, using the estimated acceptability, the sales promotion plan determination unit 103 determines a sales promotion plan to be provided to the user with reference to information in which an acceptability and a sales promotion plan are associated with each other.

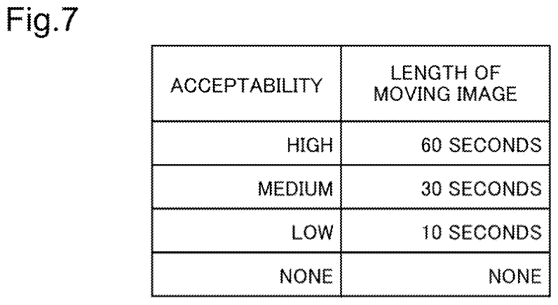

FIG. 7 is an example of information in which an acceptability and a sales promotion plan are associated with each other. In FIG. 7, a type of a sales promotion plan is only a moving image, and information in which an acceptability and an amount of the sales promotion plan are associated with each other is shown. The amount of the sales promotion plan is set so that the higher the acceptability is, the higher burden the sales promotion plan imposes, that is, the longer length the moving image has. Based on the information shown in FIG. 7, for example, in a case where the acceptability is “medium”, the sales promotion plan determination unit 103 determines a video of 30 seconds as a sales promotion plan to be provided to the user. In a case where there are a plurality of types of contents of sales promotion plans, the sales promotion plan determination unit 103 may determine a sales promotion plan by searching a sales promotion plan database for a 30-second video based on the preference of the user.

Here, the sales promotion plan database is a database that stores information on a sales promotion plan. The information on a sales promotion plan includes, for example, information on a program or data for providing the sales promotion plan, the type of sales promotion plan, a content of the sales promotion plan, an amount of the sales promotion plan, and a category of a preference of a relevant user. The sales promotion plan database may be provided inside the sales promotion support device or outside the sales promotion support device 100 in a communicable manner.

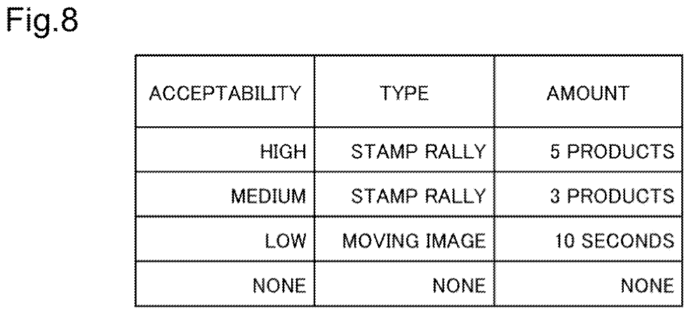

FIG. 8 is another example of information in which an acceptability and a sales promotion plan are associated with each other. In FIG. 8, a type of a sales promotion plan is a stamp racket or a moving image, and information in which an acceptability, a type of a sales promotion plan, and an amount of the sales promotion plan are associated with each other is shown. When there are a plurality of types of sales promotion plans, the sales promotion plan determination unit 103 determines a sales promotion plan according to the information in which the acceptability, the type of the sales promotion plan, and the amount of the sales promotion plan are associated with each other.

The information in which the acceptability and the sales promotion plan are associated with each other is not limited thereto.

Furthermore, the sales promotion plan determination unit 103 may determine a sales promotion plan with respect to a combination of a temporal acceptability and a walk-around acceptability.

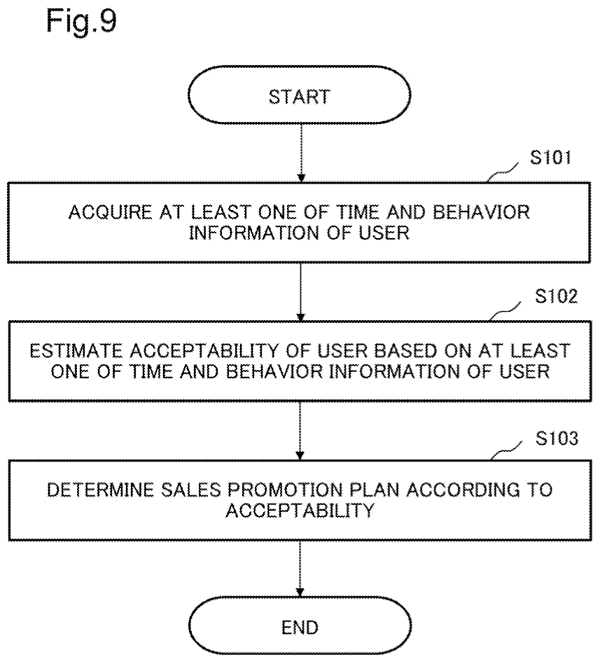

An operation of the sales promotion support device 100 configured as described above will be described with reference to a flowchart of FIG. 9.

FIG. 9 is a flowchart illustrating an outline of an operation of the sales promotion support device 100 according to the example embodiment. Note that the process according to this flowchart may be executed based on a program control by a processor.

As illustrated in FIG. 9, first, the acquisition unit 101 acquires at least one of a time and behavior information of the user (step S101).

Next, the acceptability estimation unit 102 estimates an acceptability of the user based on the at least one of the time and the behavior information of the user acquired in step S101 (step S102).

Next, the sales promotion plan determination unit 103 determines a sales promotion plan according to the acceptability estimated in step S102 (step S103).

Then, the sales promotion support device 100 ends a series of operations. The series of operations may be repeatedly executed. In addition, the sales promotion support device 100 may repeatedly execute the series of operations for each user. Furthermore, the determined sales promotion plan may be provided to the user terminal by the sales promotion support device 100, an external server, or the like.

In the sales promotion support device according to the present example embodiment described above, the acceptability estimation unit estimates an acceptability of the user to the sales promotion plan based on at least one of behavior information that is information regarding a behavior of the user and a time. Then, the sales promotion plan determination unit determines a sales promotion plan to be provided to the user according to the acceptability.

With such a configuration, the sales promotion support device 100 determines a sales promotion plan that can be accepted according to the situation of the user, such that the user can be provided with the sales promotion plan that is easy to accept. As a result, the sales promotion support device according to the present exemplary embodiment can support provision of a sales promotion plan without making the user feel annoyed.

### [First Modification]

Next, a first modification of the example embodiment of the present disclosure will be described in detail with reference to the drawings.

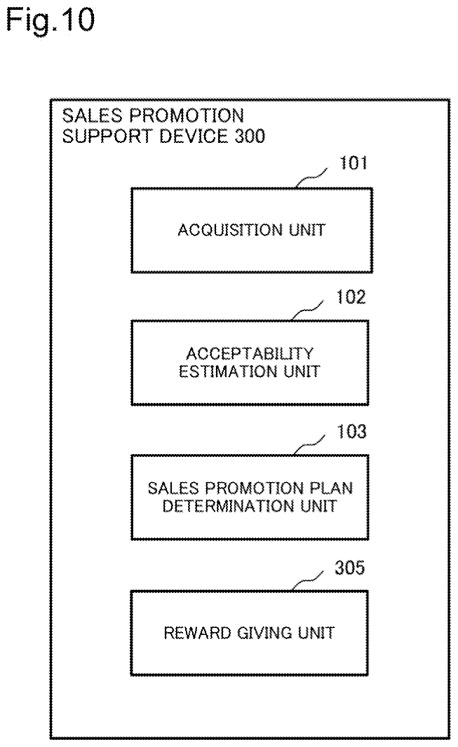

FIG. 10 is a block diagram illustrating a configuration of a sales promotion support device according to the first modification of the example embodiment of the present disclosure. A sales promotion support device 300 according to the first modification of the exemplary embodiment includes a reward giving unit 305 in addition to the components of the exemplary embodiment. Similarly to the sales promotion support device 100, the sales promotion support device 300 may be applied to the sales promotion support system.

The reward giving unit 305 is an example of a reward giving means configured to give a reward to the user according to the amount of sales promotion plan executed by the user. For example, first, the reward giving unit 305 acquires an amount of the sales promotion plan executed by the user. Next, the reward giving unit 305 determines a reward to be given to the user, using the amount of the sales promotion plan executed by the user, with reference to predetermined information in which the amount of the sales promotion plan and the reward are associated with each other. Then, the reward giving unit 305 gives the reward to the user.

The reward is, for example, a discount coupon. The discount coupon may be for a specific product related to a product or a manufacturer that is a content of the sales promotion plan. In addition, the reward may be adding points or providing a trial product or a product as a present. Such a reward further promotes participation of the user in the sales promotion plan.

For example, the reward giving unit 305 may give a larger reward to the user as the amount of the sales promotion plan executed by the user is larger. By changing the reward according to the amount of the sales promotion plan as described above, the participation of the user in the sales promotion plan is further promoted.

### [Second Modification]

In a second modification of the example embodiment, a case where the acceptability estimation unit 102 estimates that the acceptability is lower than the reference value, and a case where the sales promotion plan determination unit 103 does not provide a sales promotion plan will be described.

Based on the behavior information described above, the acceptability estimation unit 102 estimates that the acceptability is lower than the reference value in a situation where the user should not execute the sales promotion plan or in a case where there is a remarkably low possibility that the user executes the sales promotion plan. In the following description, the reference value of acceptability is a lower limit of the acceptability at which the user can execute the sales promotion plan. Note that the reference value is not limited to this example, and the sales promotion support device 100 may be configured to be able to select not to provide the sales promotion plan according to the situation of the user.

For example, as illustrated in the example of FIG. 4, when the moving speed is larger than a certain value, the acceptability may be set to be lower than the reference value (“none” as the acceptability in the example of FIG. 4). This is because, in a case where the moving speed is large, there is a high possibility that the user is moving outside the store or is in a hurry, and thus, it is assumed that there is a low possibility that the user may participate in the sales promotion plan.

Similarly, also in the examples of FIGS. 5 and 6, the acceptability is set to be lower than the reference value (“none” as the acceptability in the examples of FIGS. 5 and 6) in a time zone until the user leaves home, a working time zone, or a time zone when there is a schedule, in which it is assumed that there is a low possibility that the user participates in the sales promotion plan.

Then, when the acceptability is lower than the reference value, the sales promotion plan determination unit 103 may determine not to provide a sales promotion plan to the user.

As shown in the examples of FIGS. 7 and 8, the sales promotion plan determination unit 103 determines a sales promotion plan when the acceptability is equal to or higher than the reference value, and in the examples, when the acceptability is “low” or higher. That is, when the acceptability is lower than the reference value, and in the examples, when the acceptability is “none”, the sales promotion plan determination unit 103 determines not to provide a sales promotion plan.

For example, in a case where the user is walking on a road, it is considered that a sales promotion plan should not be executed because it is dangerous to walk while looking at the terminal device, not looking forward. In a case where it is assumed that the user is walking on a road or the like outside the store based on the position information and the moving speed of the user, the acceptability estimation unit 102 estimates that the acceptability of the user is lower than the reference value. Then, since the acceptability is lower than the reference value, the sales promotion plan determination unit 103 determines not to provide a sales promotion plan to the user.

Furthermore, for example, when the user is working, it is considered that there is a remarkably low possibility that the user executes a sales promotion plan. In a case where it is assumed that the user is working based on the position information or the behavior schedule of the user, the acceptability estimation unit 102 estimates that the acceptability of the user is lower than the reference value. Then, since the acceptability is lower than the reference value, the sales promotion plan determination unit 103 determines not to provide a sales promotion plan to the user.

The case where no sales promotion plan is provided, that is, the case where the acceptability estimation unit 102 estimates that acceptability is equal to or lower than the reference value, is not limited to these examples. The sales promotion support device 100 only needs to be configured to determine not to provide a sales promotion plan when the user should not execute a sales promotion plan or when there is a remarkably low possibility that the user executes a sales promotion plan based on at least one of the behavior information and the time.

### [Third Modification]

In a third modification of the example embodiment, a case where the sales promotion plan determination unit 103 presents options for a sales promotion plan will be described.

The sales promotion plan determination unit 103 may present a plurality of candidates for a sales promotion plan to the user. As a result, the user can select a sales promotion plan according to a his/her condition or preference. Furthermore, the user may select one or more sales promotion plans.

In the example of the information in which the acceptability and the sales promotion plan are associated with each other in FIGS. 7 and 8, one combination of a type and an amount of a sales promotion plan is set for each level of the acceptability, but in the third modification, a plurality of combinations of types and amounts of sales promotion plans may be set for each level of the acceptability. Alternatively, in addition to the sales promotion plan corresponding to the estimated acceptability, the sales promotion plan determination unit 103 may cause the user terminal to display, as an option of a sales promotion plan, a sales promotion plan of which a level is close to that of the estimated acceptability, for example, a sales promotion plan corresponding to an acceptability one level higher or a sales promotion plan corresponding to an acceptability one level lower, such that the user selects a sales promotion plan.

Furthermore, in a case where options are presented, the sales promotion plan selected by the user and data on the situation of the user at that time may be accumulated in a storage unit communicably connected to the inside or the outside of the sales promotion support device 100 or 200. The accumulated data may be used for estimating an acceptability and determining a sales promotion plan. For example, the accumulated data may be used to create or update information indicating a relationship between behavior information and an acceptability, information indicating a relationship between a time and an acceptability, and information in which an acceptability and a sales promotion plan are associated with each other. Alternatively, the accumulated data may be used to train a trained model used for estimating an acceptability and determining a sales promotion plan.

### Example of Usage Scene

Referring back to FIG. 2, which illustrates a concept of the sales promotion support system 10, an example of a usage scene of the present disclosure will be described.

The acquisition unit 101 of the sales promotion support device 100 acquires behavior information used for estimating an acceptability of the user, for example, from the user terminal 400. Alternatively, the acquisition unit 101 of the sales promotion support device 100 may acquire behavior information used for estimating an acceptability of the user from another server or database to which the user terminal 400 is communicably connected to store information regarding the user. The acceptability estimation unit 102 estimates an acceptability of the user who uses the user terminal 400 based on at least one of the acquired behavior information and a time.

The sales promotion plan determination unit 103 of sales promotion support device 100 outputs data for the user to execute the determined sales promotion plan to the user terminal 400. The data for the user to execute the sales promotion plan may be, for example, data of a moving image, a uniform resource locator (URL) for accessing the moving image, a URL for accessing a questionnaire, data or a program for executing a stamp rally plan, or the like.

The user terminal 400 causes the user to execute the sales promotion plan using data for executing the sales promotion plan acquired from the sales promotion support device 100.

In a case where the sales promotion support device is a sales promotion support device 300, that is, in a case where the sales promotion support device includes a reward giving unit 305, the amount of the sales promotion plan executed in the user terminal 400 is acquired from the user terminal 400 to determine a reward to be given to the user. Then, the user terminal 400 acquires the reward from the reward giving unit 305.

The sales promotion support system 10 may determine whether the user is in the store, that is, whether the user terminal 400 is in the store, according to what type of sales promotion plan can be provided. For example, a sales promotion plan that enhances migration in a store, such as a stamp rally performed by scanning barcodes of products in the store, is provided when the user is in the store. Furthermore, the user can participate in a moving image, a questionnaire, and the like outside the store such as at home.

In this case, for example, the acceptability estimation unit 102 may recognize that the user has entered the store, and estimate that the user has an acceptability to a sales promotion plan for enhancing migration. Then, the sales promotion plan determination unit 103 may determine a sales promotion plan according to the acceptability.

As a method of recognizing that the user has entered the store, position information of the user terminal may be used, a two-dimensional code or the like in the store may be read by the user terminal, or the user terminal and the store may be connected to each other through wireless communication. In addition, the reading of the two-dimensional code in the store and the connection to the store through the wireless communication, which are used as a method of recognizing that the user has entered the store, are examples of behavior information indicating the behavior of the user entering the store.

Next, an example in which a sales promotion plan is provided in a store by the sales promotion support system 10 will be described.

For example, even if the user is in a hurry, the moving speed may decrease when the user is waiting in line at a cash register. From this point of view, when the acceptability estimation unit 102 estimates an acceptability using a current moving speed, a time for which the user is waiting at the cash register can be used for a sales promotion plan.

In addition, the acceptability estimation unit 102 may estimate an acceptability using an image captured by a monitoring camera in the store, as well as the moving speed, as behavior information. For example, by comparing an image captured by the monitoring camera in the store with a store entrance time or a moving speed of the user terminal, the acceptability estimation unit 102 specifies the user in the image. Then, when the specified user is waiting in line at a cash register, the acceptability estimation unit 102 may estimate that the user has an acceptability.

In this case, the acceptability estimation unit 102 also estimates that an walk-around acceptability is low or equal to or lower than the reference value because the user is waiting in line. As a result, the sales promotion plan determination unit 103 can provide a sales promotion plan that the user can execute while standing in a waiting line at the cash register, as a sales promotion plan provided to the user.

Next, an example in which a sales promotion plan is started by the sales promotion support system 10 will be described.

For example, the sales promotion support system 10 may notify that a sales promotion plan can be provided when the user activates and operates the user terminal 400 owned by the user.

In this case, the acceptability estimation unit 102 may estimate an acceptability using whether the terminal of the user is activated or operated as behavior information of the user. When the acceptability estimation unit 102 estimates that the acceptability of the user is equal to or higher than the reference value, the sales promotion plan determination unit 103 determines a sales promotion plan to be provided to the user.

In the user terminal 400, the sales promotion plan is provided and executed in an application or on a website. In a case where the user terminal 400 does not open an application or a website through which the sales promotion plan can be executed, the sales promotion plan determination unit 103 notifies the user that the sales promotion plan can be provided.

In addition, in a case where the user terminal 400 opens an application or a website through which the sales promotion plan can be executed, a button for starting the sales promotion plan may be displayed on a part of a display screen.

In addition, for example, in a case where the sales promotion plan is provided outside the store, a reference value for determining whether to provide the sales promotion plan may be set to be higher than that in a case where the sales promotion plan is provided inside the store. In other words, in a case where it is estimated that the user is outside the store based on the behavior information of the user, the acceptability estimation unit 102 may estimate that the acceptability is lower than that in a case where it is estimated that the user is inside the store.

By determining a sales promotion plan according to the situation of the user including the information indicating whether the user is in the store or outside the store as described above, the sales promotion support device and the sales promotion support system according to the present disclosure can support provision of the sales promotion plan without making the user feel annoyed.

Next, another example in which a sales promotion plan is provided in a store by the sales promotion support system 10 will be described.

For example, depending on the product that the user intends to purchase, it may be undesirable to spend a long time in the store. For example, in a case where the user intends to purchase a product having a temperature change, that is, a cold product such as a frozen product or a fresh product, or a warm product such as a freshly prepared side dish, a lunch box, or bread, the user may want to leave the store while the temperature change of the product is small. From this point of view, the sales promotion support device 100 may determine a sales promotion plan to be provided according to a product that the user intends to purchase.

In this case, first, the acquisition unit 101 acquires product information of a product that the user intends to purchase. The product information of the product that the user intends to purchase is an example of behavior information of the user. For example, the acquisition unit 101 recognizes, as a product that the user intends to purchase, a type, a name, or an identification number of a product that the user has picked up or a product that the user has put in a shopping basket. The acquisition unit 101 may recognize the type, name, or identification number of the product using a monitoring camera of a store, a camera or a weight sensor of a product shelf, a camera of a shopping basket, a camera of a user terminal, or the like. Alternatively, in a case where the user is shopping while scanning a product to be purchased, the acquisition unit 101 may recognize an identification number of the scanned product as a product that the user intends to purchase. The acquisition unit 101 acquires product information of the recognized product from a product information database. In the product information database, the product information is stored in association with the above-described information for identifying the product, such as the type, name, and identification number of the product. The product information includes information indicating whether the product is a product that the user wants to take out quickly, for example, information indicating whether the product is a frozen product.

The acceptability estimation unit 102 estimates an acceptability of the user to the sales promotion plan based on the product information of the product that the user intends to purchase, which is behavior information. For example, in a case where the product that the user intends to purchase includes a product having a temperature change, such as a cold product such as a frozen product or a fresh product, or a warm product such as a freshly prepared side dish, a lunch box, or bread, it is estimated that the acceptability of the user is low or lower than the reference value.

The sales promotion plan determination unit 103 determines to provide either a sales promotion plan that does not take much time or determines not to provide a sales promotion plan, according to the acceptability estimated based on the product information of the product that the user intends to purchase. The sales promotion plan that does not take much time is, for example, a short moving image or a questionnaire with a small number of questions.

Note that the case where it is not preferable for the user to spend a long time in the store, and the product that the user wants to take out quickly are not limited to these examples.

As described above, also in a case where it is not preferable for the user to spend a long time in the store, the sales promotion support device and the sales promotion support system according to the present disclosure can support provision of the sales promotion plan without making the user feel annoyed.

### [Hardware Configuration]

A part or all of each component of the device or the system in each of the example embodiment of the present disclosure and the modifications thereof described above is implemented, for example, by any combination of a program with an information processing device 1000 as illustrated in FIG. 10. The information processing device 1000 includes the following components as an example.
Central processing unit (CPU) 1001
Read only memory (ROM) 1002
Random access memory (RAM) 1003
Program 1004 loaded into RAM 1003
Storage device 1005 storing program 1004
Drive device 1007 reading and writing recording medium 1006
Communication I/F 1008 connected to communication network 1009
Input/output I/F 1010 for inputting/outputting data
Bus 1011 connecting components to each other

Note that the I/F is an abbreviation of interface.

Each component of each device or system in each embodiment is implemented by the CPU 1001 acquiring and executing a program for realizing such functions. The program for implementing the functions of each component of each device is stored, for example, in the storage device 1005 or the RAM 1003 in advance, and is read by the CPU 1001 if necessary. Note that the program 1004 may be supplied to the CPU 1001 via the communication network, or may be stored in advance in the recording medium 1006 such that the drive device 1007 reads the program to be supplied to the CPU 1001.

The method for implementing each device may be modified in various manners. For example, each device or system may be implemented by any combination of a program with an information processing device 1000 separate for each component. In addition, a plurality of components included in each device may be implemented by any combination of a program with one information processing device 1000.

In addition, a part or all of each component of each device or system is implemented by general-purpose or dedicated circuitry including a processor or the like, or a combination thereof. The circuitry is, for example, a CPU, a graphics processing unit (GPU), or a field programmable gate array (FPGA). Furthermore, the circuitry may be a large scale integration (LSI) dedicated to artificial intelligence (AI) processing. These may be constituted by a single chip or may be constituted by a plurality of chips connected to each other via a bus. Some or all of each component of each device may be implemented by a combination of a program with the above-described circuitry or the like.

In a case where a part or all of each component of each device or system is implemented by a plurality of information processing devices, circuits, or the like, the plurality of information processing devices, circuits, or the like may be arranged in a centralized manner or in a distributed manner. For example, the information processing devices, the circuits, or the like may be may be connected to each other via a communication network, such as a client and server system or a cloud computing system.

An example object of the present disclosure is to support provision of a sales promotion plan that does not make a user feel annoyed.

An example effect of the present disclosure is that provision of a sales promotion plan that does not make a user feel annoyed can be supported.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

In addition, although a plurality of operations are described in order in the form of a flowchart, the order in which the operations are described does not limit an order in which the plurality of operations are executed. Therefore, when each example embodiment is implemented, the order in which the plurality of operations are executed may be changed within a range that does not interfere with the content.

Further, it is noted that the inventor's intent is to retain all equivalents of the claimed invention even if the claims are amended during prosecution.

1. A sales promotion support device comprising:
one or more memories storing instructions; and
one or more processors configured to execute the instructions to:
acquire at least one of behavior information that is information regarding a behavior of a user and a time at which a sales promotion plan is to be provided;
estimate an acceptability of the user to a sales promotion plan based on the at least one of the behavior information and the time; and
determine a sales promotion plan to be provided to the user according to the acceptability.

2. The sales promotion support device according to claim 1, wherein the one or more processors configured to execute the instructions to:
estimate the acceptability based on information indicating a relationship the at least one of the behavior information and the time with the acceptability.

3. The sales promotion support device according to claim 1, wherein the one or more processors configured to execute the instructions to:
determine at least one of a type and an amount of a sales promotion plan to be provided to the user based on the acceptability.

4. The sales promotion support device according to claim 1, wherein the one or more processors configured to execute the instructions to:
determine, as the sales promotion plan to be provided to the user, a sales promotion plan imposing a higher burden on the user in executing the sales promotion plan as the acceptability is higher.

5. The sales promotion support device according to claim 1, wherein the one or more processors configured to execute the instructions to:
determine, as the sales promotion plan to be provided to the user, a sales promotion plan imposing a lower burden on the user in executing the sales promotion plan as the acceptability is lower.

6. The sales promotion support device according to claim 1, wherein the behavior information is information on a product scanned by the user.

7. The sales promotion support device according to claim 1, wherein the behavior information is information regarding a behavior history of the user within a predetermined time.

8. The sales promotion support device according to claim 1, wherein the behavior information is information indicating a moving speed of the user within a predetermined time.

9. The sales promotion support device according to claim 1, wherein the one or more processors configured to execute the instructions to:
estimate the acceptability based on a current situation of the user estimated based on the behavior information.

10. The sales promotion support device according to claim 1, wherein the one or more processors configured to execute the instructions to:
estimate that the acceptability is lower than a reference value when estimating that the user is walking outside a store based on the behavior information.

11. The sales promotion support device according to claim 1, wherein the one or more processors configured to execute the instructions to:
provide a sales promotion plan when the acceptability is higher than or equal to a reference value.

12. The sales promotion support device according to claim 1, wherein the one or more processors configured to execute the instructions to:
determine executing a predetermined operation at a predetermined point as the sales promotion plan to be provided to the user.

13. The sales promotion support device according to claim 1, wherein the one or more processors configured to execute the instructions to:
determine watching a moving image as the sales promotion plan to be provided to the user.

14. The sales promotion support device according to claim 1, wherein the one or more processors configured to execute the instructions to:
give a reward to the user according to an amount of the sales promotion plan executed by the user.

15. The sales promotion support device according to claim 14, wherein the one or more processors configured to execute the instructions to:
give a large reward to the user when the amount of the sales promotion plan executed by the user is large.

16. A sales promotion support method performed by a computer, the sales promotion support method comprising:
acquiring at least one of behavior information that is information regarding a behavior of a user and a time at which a sales promotion plan is to be provided;
estimating an acceptability of the user to a sales promotion plan based on the at least one of the behavior information and the time; and
determining a sales promotion plan to be provided to the user according to the acceptability.

17. A recording medium that records sales a promotion support program causing a computer to execute:
acquiring at least one of behavior information that is information regarding a behavior of a user and a time at which a sales promotion plan is provided;
estimating an acceptability of the user to a sales promotion plan based on the at least one of the behavior information and the time; and
determining a sales promotion plan to be provided to the user according to the acceptability.
